(19) United States
(12) Patent Application Publication
(10) Pub. No.: US 2014/0379530 A1
(43) Pub. Date: Dec. 25, 2014

(54) INTEGRATED CARWASH CLIENT SERVICE MANAGEMENT SYSTEM WITH REAL-TIME WORK SCHEDULING PROCESS AND CARWASH ORDER AND RESERVATION FOR A CAR PARKING FACILITY-BASED HAND CARWASH

(71) Applicants: Sunghee Kim, Edmonton (CA); Eunsoo Park, Edmonton (CA)

(72) Inventors: Sunghee Kim, Edmonton (CA); Eunsoo Park, Edmonton (CA)

(21) Appl. No.: 14/306,232

(22) Filed: Jun. 17, 2014

Related U.S. Application Data
(60) Provisional application No. 61/836,667, filed on Jun. 19, 2013.

(51) Int. Cl. G06Q 30/06; G06Q 50/10; G06Q 20/18; B60S 3/04

(52) U.S. Cl. CPC G06Q 30/0635; B60S 3/04; G06Q 50/10; G06Q 20/18
USPC 705/26.81

(57) ABSTRACT

An integrated carwash client service management system receives a customer's carwash request, and schedules, coordinates, and manages a car parking facility-based hand carwash service. The integrated carwash client service management system includes an integrated carwash service management application executed in a computer server, an integrated carwash customer order application executed in a customer's electronic device, an integrated carwash order processing application executed in a carwash technician device, and an integrated carwash kiosk application executed in an electronic kiosk machine. A client service management database is managed and operated by the integrated carwash service management application executed in the computer server. This system provides an interactive electronic platform to schedule, view, and share a current progress of the carwash with before and after photos, messages, and status updates between the carwash technicians and the customer. The interactive electronic platform also accommodates carwash and auto detailing sales transactions.

### FIELD OF THE INVENTION

The present invention generally relates to computerized infrastructure for carwash and auto detailing services. More specifically, the present invention relates to electronic data management systems that accommodate customer service order, service reservation, service-related dynamic information transmission, and service scheduling for carwash and auto detailing services.

### BACKGROUND OF INVENTION

Conventional methods of carwash generally require a customer to drive his or her to a particular carwash shop location. Furthermore, conventional carwash services typically utilize a fully-automatic or partially-automated carwash machine, or a hand carwash with carwash crews manually washing, cleaning, and drying each vehicle. These conventional methods of carwash have certain drawbacks, such as requiring a customer to visit a particular carwash shop location and then also requiring the customer to physically wait in line until other vehicles in front of the customer's vehicle is cleared. Therefore, busy professionals and other time-constrained drivers often resort to delaying the carwash, or instead wash their vehicles at home in spare time.

Similarly, auto detailing shops typically also require a customer to leave his or her vehicle at a particular auto detail shop, so that the vehicle can be washed, waxed, coated with specialized chemicals, and/or even repaired for paint imperfections and scratches inside or outside of the vehicle. Some auto detail shops combine carwash services as their service offerings, while other auto detail shops specialize in waxing, coating, and/or repairing cosmetic or aesthetic imperfections on vehicles. Similar to a conventional carwash shop, a conventional auto detailing shop also inconveniences the customer by requiring a customer to visit a particular auto detailing location and then also by requiring the customer to physically wait in line until other vehicles in front of the customer's vehicle is cleared.

From the carwash service and the auto detailing industry's perspective, these drawbacks associated with conventional methods of carwash are lost business opportunities and lost revenue. Therefore, in certain markets, mobile onsite carwash and auto detailing services that can utilize a truck or a van to carry carwash equipment and carwash technicians to a customer's particular facility, such as the customer's office parking lot or the customer's residential driveway, have shown their business potential as a profitable niche segment of the carwash service industry. An additional advantage of the mobile onsite carwash and auto detailing services is a better attention to detail from a customer's perspective, and a higher profit margin from a service provider's perspective. Because a typical customer requesting the mobile onsite carwash and/or auto detailing service is willing to pay premium for the convenience of having the carwash completed at his or her preferred location, it is common for the typical mobile onsite carwash service customer to request value-added services, such as interior cleaning, detailing, and waxing.

Furthermore, recent technological advancements in environmentally-friendly steam car washers and biodegradable waxes and cleaners further improve the appeal of the mobile onsite carwash services as environmentally-friendly solutions for the premium custom carwash segment. From a customer's perspective, the mobile onsite carwash and/or auto detailing services provide a time-saving and highly-customized premium carwash experience unmatched by carwash shop-based services.

In general, these mobile onsite carwash and/or auto detailing services can be reserved by phone or by an Internet-based computerized interface. However, the existing methods of mobile onsite carwash and/or auto detailing services typically require advanced reservation by at least 2-3 days, and if a preferred time slot is not available due to a high level of demand, the customer has to go through the inconvenience of selecting a less ideal time slot. Furthermore, the existing methods of mobile onsite carwash and auto detailing services also suffer from a lack of systematic real-time transparent communications between a customer and a carwash crew (e.g. carwash technicians) during a carwash process, and also suffer from a security risk for handling car keys before and after a mobile onsite carwash service is provided.

A novel and more advantageous strategy may be providing a carwash or auto detail service at a car parking facility itself without requiring a fixed carwash machine inside the car parking facility or a fixed carwash infrastructure. For example, a mobile carwash or auto detail crew (e.g. carwash technicians) may directly go to a parked car space at a particular parking spot inside the car parking facility, and provide carwash, cleaning, and auto detail services based on a novel and highly-streamlined carwash scheduling and management information technology (IT) infrastructure, which at present does not exist in the carwash and the auto detail industry.

Therefore, it will be highly beneficial to provide a novel computerized system with embedded and mobile application software that receives carwash requests and schedule, coordinate, and manage a car parking facility-based hand carwash service. Furthermore, it will also be highly beneficial to provide user interface application software and user interface devices that can enter a customer's carwash and/or auto detailing request and technician's various inputs in real-time to schedule, view, share, and generate feedback during and after the car parking facility-based hand carwash service. In addition, it will also be beneficial to provide a real-time communication and an e-commerce transaction network to accommodate a customer's carwash fee payment and various communication needs between the customer and carwash technicians after the customer's carwash request is accepted by the novel computerized system.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In general, the present invention relates to various embodiments of one or more integrated carwash client service management systems with real-time work scheduling process and carwash order and reservation for a car parking facility-based hand carwash.

In one embodiment of the invention, an integrated carwash client service management system is disclosed. This system comprises: an integrated carwash customer order application executed in a customer's electronic device, wherein the integrated carwash customer order application provides a carwash order and payment interactive user interface on a display screen of the customer's electronic device; an integrated carwash order processing application executed in a carwash technician's electronic device, wherein the integrated carwash order processing application provides a carwash work schedule and a computerized voice or visual instruction for the carwash technician's pre-carwash, carwash, and post-carwash tasks on the carwash technician's electronic device; and an integrated carwash service management application executed in a computer server, wherein the integrated carwash service management application communicates with the integrated carwash customer order application executed in the customer's electronic device, the integrated carwash order processing application executed in the carwash technician's electronic device, and a client service management database to coordinate and assist a hand car wash in a car parking facility that involves the carwash technician locating and washing a vehicle on the customer's designated parking space in the car parking facility.

In another embodiment of the invention, a method of operating an integrated carwash client service management system is disclosed. This method comprises the steps of: executing an integrated carwash service management application in a computer server; executing an integrated carwash customer order application in a customer's electronic device; executing an integrated carwash order processing application in a carwash technician's electronic device; executing an integrated carwash kiosk application in an electronic kiosk machine; receiving a carwash order and an associated payment via an interactive user interface provided by a display panel in the customer's electronic device executing the integrated carwash customer order application, or by a kiosk display panel in the electronic kiosk machine executing the integrated carwash kiosk application; processing the associated payment by the computer server and by a payment processing entity; storing the carwash order in a client service management database operated by the integrated carwash service management application and the computer server; generating computerized voice or visual instructions for the carwash technician's pre-carwash, carwash, and post-carwash tasks that are defined by the integrated carwash service management application; transmitting the computerized voice or visual instructions to the carwash technician's electronic device; and playing the computerized voice or visual instructions on the carwash technician's electronic device, so that the carwash technician follows each instruction from the computerized voice or visual instructions for the carwash technician's pre-carwash, carwash, and post-carwash tasks.

### BRIEF DESCRIPTION OF DRAWINGS

FIG. 1 shows a block diagram comprising various system components of an integrated carwash client service management system, in accordance with an embodiment of the invention.

FIG. 2 shows a flowchart for a carwash order and payment process in accordance with an embodiment of the invention.

FIG. 3 shows a flowchart for a carwash scheduling process upon receipt of a customer order, in accordance with an embodiment of the invention.

FIG. 4 shows a flowchart for a carwash scheduling process in case of a customer order with an advanced reservation, in accordance with an embodiment of the invention.

FIG. 5 shows a flowchart for a carwash scheduling update process in accordance with an embodiment of the invention.

FIG. 6 shows a flowchart for a carwash technician's process in accordance with an embodiment of the invention.

FIG. 7 shows a flowchart for a communication process generated by an integrated carwash client service management system before a carwash operation, in accordance with an embodiment of the invention.

FIG. 8 shows a flowchart for a communication process generated by an integrated carwash client service management system after a carwash operation, in accordance with an embodiment of the invention.

FIG. 9 shows a flowchart for a communication process generated by an integrated carwash client service management system for a carwash technician's note, in accordance with an embodiment of the invention.

FIG. 10 shows a flowchart for a communication process generated by an integrated carwash client service management system for a customer's feedback, in accordance with an embodiment of the invention.

FIG. 11 shows a method for operating an integrated carwash client service management system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and/or other symbolic representations that directly or indirectly resemble one or more integrated carwash client service management system and related methods of operation. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to one or more integrated carwash client service management systems. Furthermore, embodiments of the invention also relate to one or more methods of operating one or more integrated carwash client service management systems.

In addition, embodiments of the invention also relate to user interface application software and user interface devices that can enter a customer's carwash request and technician's various inputs in real-time to schedule, view, share, and generate feedback during and after the car parking facility-based hand carwash service.

Moreover, embodiments of the invention further relate to a real-time communication and an e-commerce transaction network that accommodates a customer's carwash fee payment, associated sales transaction, and various communication needs between the customer and carwash technicians after the customer's carwash request is accepted by an integrated carwash client service management system.

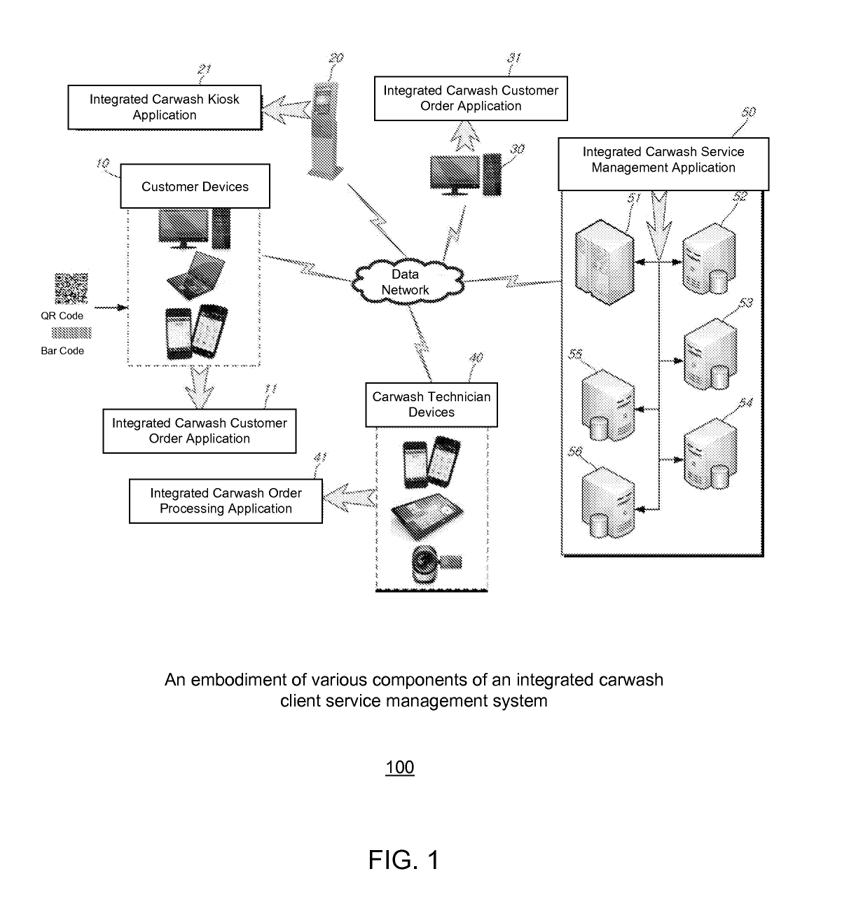

FIG. 1 shows a block diagram comprising various system components of an integrated carwash client service management system (100), in accordance with an embodiment of the invention. In a preferred embodiment of the invention, the integrated carwash client service management system (100) includes an integrated carwash kiosk application (21), which is executed by a CPU and a memory unit of an electronic kiosk machine (20). This integrated carwash kiosk application (21) provides a customer-side user interface that enables a customer standing in front of the electronic kiosk machine (20) to select a particular carwash service and a payment method. The integrated carwash kiosk application (21) executed on the electronic kiosk machine (20) may also accommodate credit card swiping or other forms of payment for associated sales transaction completion with payment transaction entities and systems.

Furthermore, the integrated carwash client service management system (100) in the preferred embodiment of the invention also includes an integrated carwash customer order application (11, 31), which can be executed on a CPU and a memory unit of a customer's portable electronic device (10) or a desktop computer (30). The customer's portable electronic devices (10) may be a notebook computer, a smart phone, a tablet computer, or another portable electronic device. The integrated carwash customer order application (11, 31) can provide a computerized user interface for carwash orders, payments, status updates, and/or communication with carwash crews on a display screen of a customer's portable electronic device or a desktop computer. For example, by interacting with a mobile application version of the integrated carwash customer order application (11) executed on a smart phone, the customer is able to select and execute a particular carwash service and a payment method. Preferably, the customer is also able to complete payments by utilizing a credit card or another electronic payment method accommodated by the integrated carwash customer order application (11, 31).

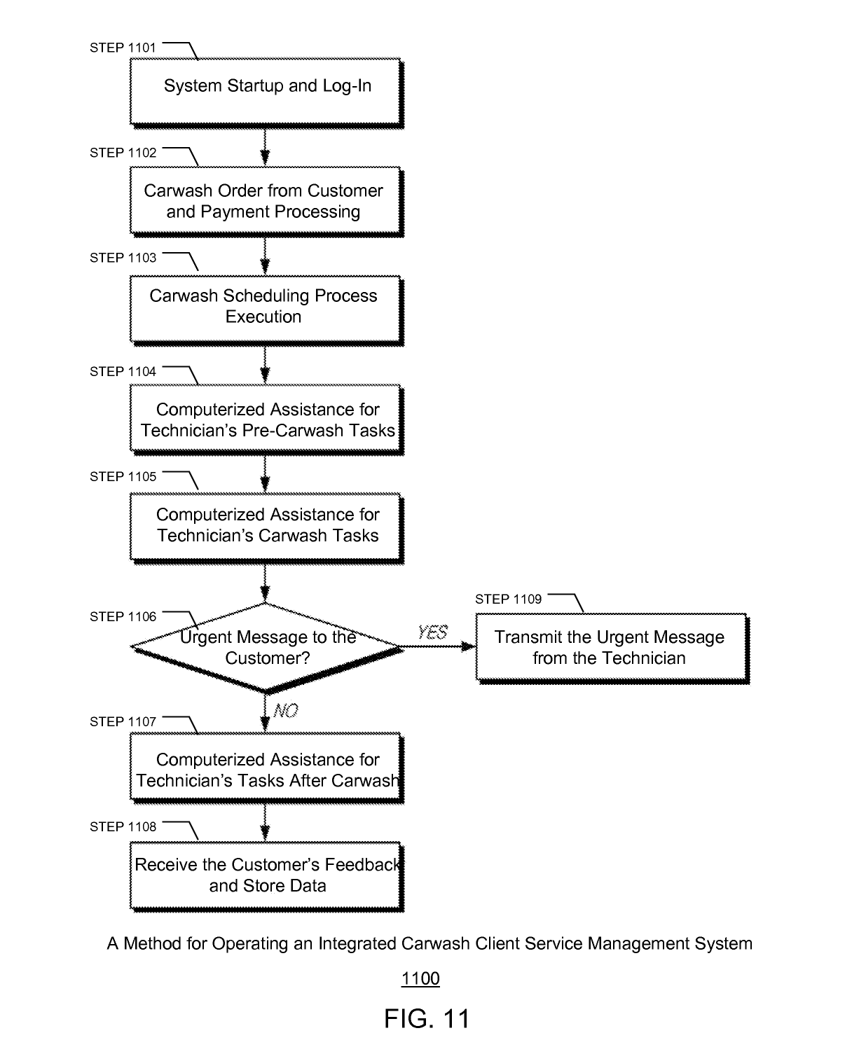

Furthermore, the computerized user interface provided by the integrated carwash customer order application (11, 31) can also accommodate carwash status updates and real-time communication with carwash technicians after the selection of a particular carwash service and payments are completed. In addition, car wash orders, discount coupons, or payment coupons represented in form of QR codes and bar codes can be read and deciphered by the integrated carwash customer order application (11, 31), as shown in FIG. 11n some embodiments of the invention, a customer who utilized the electronic kiosk machine (20) and the integrated carwash kiosk application (21) may be able to receive carwash status updates and communicate in real-time with carwash technicians via the integrated carwash customer order application (11, 31), which can be downloaded and/or executed on the customer's portable electronic device or the customer's desktop computer.

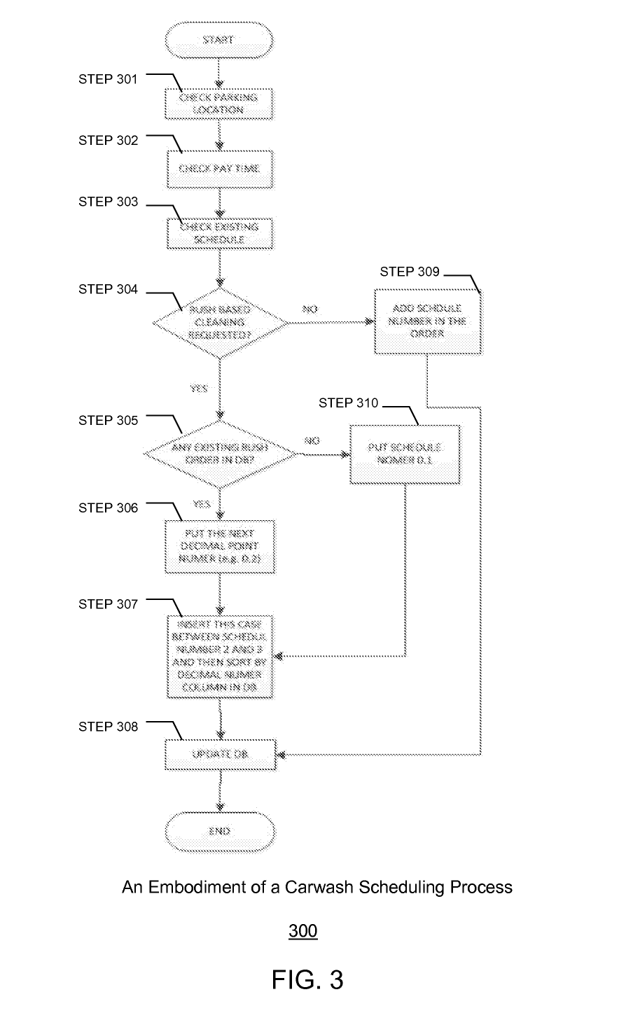

Continuing with FIG. 1, the integrated carwash client service management system (100) in the preferred embodiment of the invention also includes an integrated carwash order processing application (41), which is executed on a CPU and a memory unit of a carwash technician device (40). The carwash technician device (40) may include, but is not limited to, a smart phone, a tablet computer, a notebook computer, a desktop computer, or another electronic device utilized by one or more carwash technicians. Preferably, the integrated carwash order processing application (41) is configured to process, receive, and/or display carwash scheduling and computerized instructions and assistance for a carwash technician's pre-carwash, carwash, and post-carwash tasks that are defined and coordinated by the integrated carwash service management application (50), which is executed in one or more computer servers (51, 52, 53, 54, 55, 56), as shown in FIG. 1. The carwash technician's pre-carwash, carwash, and post-carwash tasks, which are assisted and instructed by the integrated carwash service management application (50) and the integrated carwash order processing application (41), are further shown in FIGS. 3-9, FIG. 11, and corresponding descriptions in the specification.

Moreover, the integrated carwash client service management system (100) in the preferred embodiment of the invention also includes the integrated carwash service management application (50), which is executed by one or more computer servers (51, 52, 53, 54, 55, 56). Preferably, the integrated carwash service management application (50) is configured to receive customer order information from the integrated carwash customer order applications (11, 31) and the integrated carwash kiosk application (21). The integrated carwash service management application (50) can then schedule, coordinate, define, and manage carwash scheduling and the carwash technician's pre-carwash, carwash, and post-carwash tasks. For scheduling and management of the carwash technician's pre-carwash, carwash, and post-carwash tasks, the integrated carwash service management application (50) may also communicate with the integrated carwash order processing application (41) executed on the carwash technician device (40) and the integrated carwash customer order applications (11, 31) executed on the customer's portable electronic device (10) or the customer's desktop computer (30), so that any significant status updates, customer feedback, technician feedback, or other data can be dynamically coordinated and managed by the integrated carwash service management application (50).

As shown in FIG. 1, various components of the integrated carwash client service management system (100) are connected by a combination of wired and wireless data networks. In case of the preferred embodiment of the invention, the integrated carwash kiosk application (21) executed in the electronic kiosk machine (20), the integrated carwash customer order applications (11, 31) executed on the customer's portable electronic device (10) or the desktop computer (30), the integrated carwash order processing application (41) executed on the carwash technician device (40), and the integrated carwash service management application (50) executed on one or more computer servers (51, 52, 53, 54, 55, 56) communicate by a combination of wired and wireless data networks, such as physical local area network (LAN), wide-area network (WAN), cellular service networks, and the Internet.

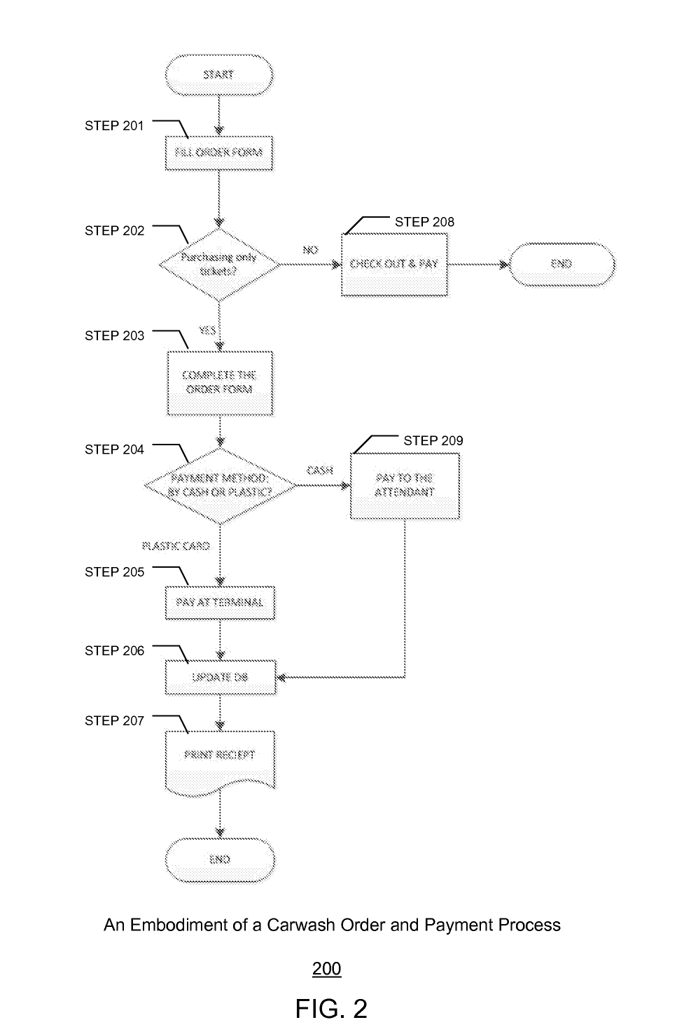

FIG. 2 shows a flowchart (200) for a carwash order and payment process in accordance with an embodiment of the invention. In a preferred embodiment of the invention, the carwash order and payment process are provided to a customer by an integrated carwash kiosk application (21 in FIG. 1) executed on the electronic kiosk machine (20 in FIG. 1), or by an integrated carwash customer order application (11 or 31 in FIG. 1) executed on a customer's electronic device (10 or 30 in FIG. 1). As shown in STEP 201 in the flowchart (200) of FIG. 2, in the preferred embodiment of the invention, the integrated carwash kiosk application (21 in FIG. 1) or the integrated carwash customer order application (11 or 31 in FIG. 1) provides a fill order form to the customer on a display screen of the electronic kiosk machine (20 in FIG. 1) or the customer's electronic device (10 or 30 in FIG. 1). The fill order form may include a menu selection for several levels of carwash services that are differentiated by carwash service coverage and prices.

For example, the menu selection associated with the fill order form may include a “basic” carwash service, an “intermediate” carwash service, and a “premium” carwash service that are differentiated by interior cleaning, exterior waxing, undercarriage wash, and/or professional hand detailing of the exterior surfaces of a vehicle. Typically, the price offering of a particular carwash service is higher if more services (e.g. interior cleaning, exterior waxing, undercarriage wash, professional hand detailing, and etc.) are included in the particular carwash service. Furthermore, in some embodiments of the invention, a “rush” service may be requested by the customer at a premium price in the menu selection associated with the fill order form. Moreover, the menu selection also provides the customer to indicate a parking location of the customer's vehicle, so that a carwash technician can subsequently locate and identify the customer's vehicle for onsite carwash, once the order form and the payment processes are completed.

Furthermore, as shown in STEP 202 in the flowchart (200), the fill order form may also provide the customer a menu to only purchase a carwash ticket to check out and complete payment immediately, as shown in STEP 208, or to complete the fill order form to specify all of the desired options and/or a desired time slot for the carwash service during the carwash order and payment process, as shown in STEPS 203˜207 in FIG. 2. If the customer decides to only purchase the carwash ticket immediately, the customer may not need to specify all of the desired options and/or the desired time slot for the carwash service prior to a checkout and payment process as shown in STEP 208. With a purchased carwash ticket, the customer may simply utilize the integrated carwash kiosk application (21 in FIG. 1) or the integrated carwash customer order application (11 or 31 in FIG. 1) at a later time period to specify desired options and a desired carwash service time slot for the carwash ticket.

On the other hand, if the customer decides to proceed with specifying the desired options for the carwash order at the time of the carwash ticket purchase, then the customer can complete the fill order form, as shown in STEP 203, by specifying a particular carwash service option (e.g. a “basic” carwash service, an “intermediate” carwash service, and a “premium” carwash service, and etc.) and a desired carwash service time slot. Then, by utilizing the user interface menu provided by the integrated carwash kiosk application (21 in FIG. 1) or the integrated carwash customer order application (11 or 31 in FIG. 1), the customer can also choose a payment method (e.g. cash or credit card, as shown in STEP 204), and decide to pay to a carwash attendant, if available, as shown in STEP 209, or pay electronically on an electronic kiosk machine (20 in FIG. 1) or on a customer's own electronic device (10 or 30 in FIG. 1), as shown in STEP 205.

Continuing with the flowchart (200) in FIG. 2, the customer's payment information entered by the customer or by the carwash attendant is then processed by the integrated carwash client service management system (100 in FIG. 1) and one or more associated electronic payment gateways and providers (e.g. Visa, MasterCard, Chase Paymentech, PayPal, and etc.) for completion of associated carwash sales transaction. Confirmations of payments are updated to a computerized database managed by the integrated carwash service management application (50 in FIG. 1) executed on one or more computer servers (51, 52, 53, 54, 55, 56 in FIG. 1), as shown in STEP 206. Then, the electronic kiosk machine (20 in FIG. 1) or a printer device connected to the customer's electronic device (10 or 30 in FIG. 1) can print a receipt for the customer's payment, as shown in STEP 207. It should be noted that the carwash order and payment processing, as shown in the flowchart (200), is merely one preferred embodiment of the invention, and other methods and processes for the carwash order and payment processing may be incorporated in other embodiments of the invention.

FIG. 3 shows a flowchart (300) for a carwash scheduling process upon receipt of a customer order, in accordance with an embodiment of the invention. In this embodiment of the invention, the carwash scheduling process is managed and coordinated by the integrated carwash service management application (50 in FIG. 1) executed on one or more computer servers (51, 52, 53, 54, 55, 56 in FIG. 1) for the integrated carwash client service management system. As shown in STEP 301 of the flowchart (300), the integrated carwash service management application (50 in FIG. 1) checks the parking location of the customer's vehicle based on the customer's input in the fill order form. The integrated carwash service management application (50 in FIG. 1) also checks the payment time for the customer, as shown in STEP 302, and the existing carwash schedule that are already queued into the client service management database, as shown in STEP 303.

Then, the integrated carwash service management application (50 in FIG. 1) checks whether the customer requested a rush carwash service, as shown in STEP 304. If the rush carwash service is not requested, then the integrated carwash service management application (50 in FIG. 1) simply queues the current carwash order into the client service management database on a first-come-first-served basis. For example, a chronological “schedule number” may be assigned to the current carwash order, as shown in STEP 309, and then entered into the client service management database, as shown in STEP 308.

On the other hand, if the rush carwash service is requested, then the integrated carwash service management application (50 in FIG. 1) checks whether there are any existing rush carwash services ahead of the current carwash order, as shown in STEP 305. If there are no existing rush carwash services ahead of the current carwash order, then a priority assignment can be made to enable the current carwash order to be the next order to be executed. As shown in STEP 310 and STEP 307, an example of the priority assignment may be placing a special schedule number (e.g. “0.1”) to make the current carwash order to be served immediately next, instead of being queued in the first-come-first-served order assignments. Furthermore, as shown in STEP 306 and STEP 307, if there are existing rush carwash services ahead of the current carwash order, then a first-come-first-served order assignment queue can be created and/or updated just for the rush carwash services, which receive faster and preferential order processing relative to a regular first-come-first-served order assignment queue for the non-rush carwash services. Moreover, any creations or modifications of carwash scheduling orders can be stored in the client service management database, as shown in STEP 308.

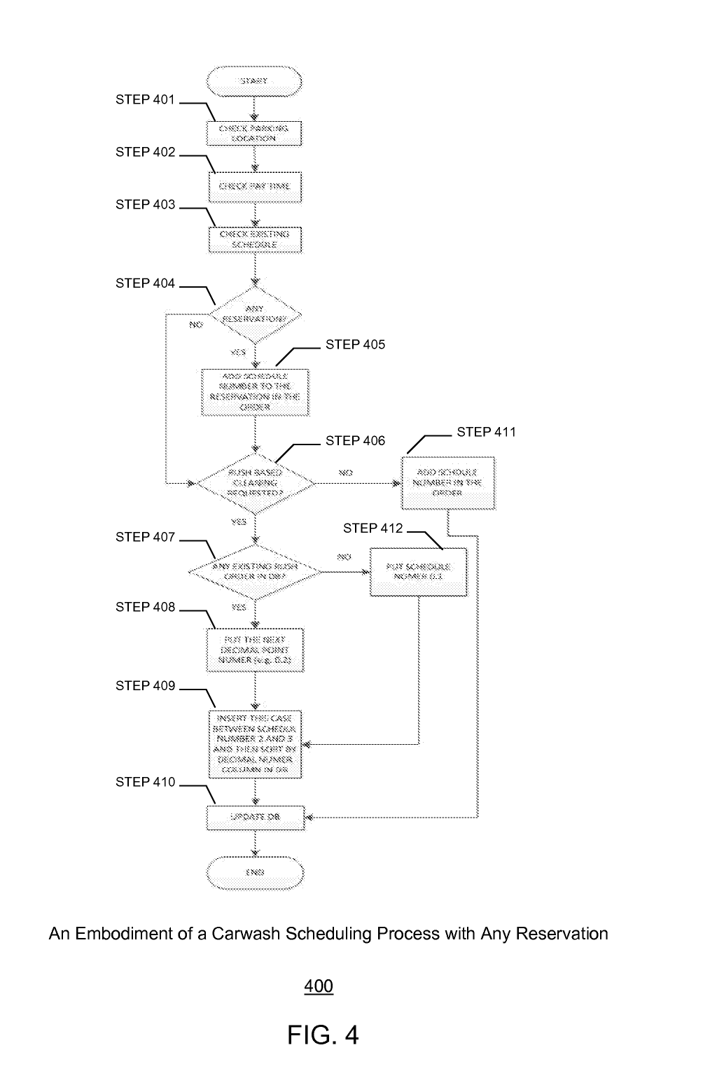

FIG. 4 shows a flowchart (400) for a carwash scheduling process in case of a customer order with an advanced reservation, in accordance with an embodiment of the invention. In this embodiment of the invention, the carwash scheduling process is managed and coordinated by the integrated carwash service management application (50 in FIG. 1) executed on one or more computer servers (51, 52, 53, 54, 55, 56 in FIG. 1) for the integrated carwash client service management system. As shown in STEP 401 of the flowchart (400), the integrated carwash service management application (50 in FIG. 1) checks the parking location of the customer's vehicle based on the customer's input in the fill order form. The integrated carwash service management application (50 in FIG. 1) also checks the payment time for the customer, as shown in STEP 402, and the existing carwash schedule that are already queued into the client service management database, as shown in STEP 403.

In order to accommodate the customer order with the advanced reservation, the integrated carwash service management application (50 in FIG. 1) then checks whether the current carwash order is flagged as a future reservation with a desired time slot indicated by the customer, as shown in STEP 404. If the current carwash order incorporated the desired time slot as the future reservation, then the integrated carwash service management application (50 in FIG. 1) updates the client service management database with a special schedule number that reflects the delayed carwash processing in accordance with the desired time slot indicated by the customer, as shown in STEP 405. On the other hand, if the current carwash order is not flagged as a future reservation, then the integrated carwash service management application (50 in FIG. 1) simply advances the scheduling process to STEP 406, as shown in the flowchart (400) in FIG. 4.

In this embodiment of the invention, the integrated carwash service management application (50 in FIG. 1) then checks whether the customer requested a rush carwash service, as shown in STEP 406. If the rush carwash service is not requested, then the integrated carwash service management application (50 in FIG. 1) simply queues the current carwash order into the client service management database on a first-come-first-served basis. For example, a chronological “schedule number” may be assigned to the current carwash order, as shown in STEP 411, and then entered into the client service management database, as shown in STEP 410.

On the other hand, if the rush carwash service is requested, then the integrated carwash service management application (50 in FIG. 1) checks whether there are any existing rush carwash services ahead of the current carwash order, as shown in STEP 407. If there are no existing rush carwash services ahead of the current carwash order, then a priority assignment can be made to enable the current carwash order to be the next order to be executed. As shown in STEP 412 and STEP 409, an example of the priority assignment may be placing a special schedule number (e.g. “0.1”) to make the current carwash order to be served immediately next, instead of being queued in the first-come-first-served order assignments. Furthermore, as shown in STEP 408 and STEP 409, if there are existing rush carwash services ahead of the current carwash order, then a first-come-first-served order assignment queue can be created and/or updated just for the rush carwash services, which receive faster and preferential order processing relative to a regular first-come-first-served order assignment queue for the non-rush carwash services. Moreover, any creations or modifications of carwash scheduling orders can be stored in the client service management database, as shown in STEP 410.

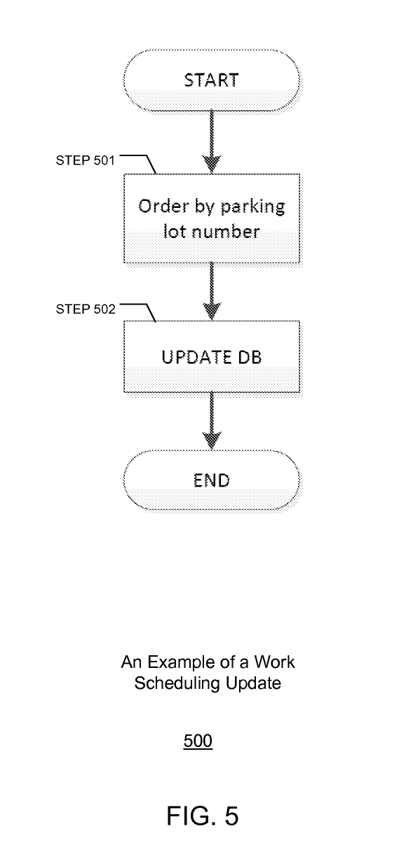

FIG. 5 shows a flowchart (500) for a carwash scheduling update process in accordance with an embodiment of the invention. In this example, a customer may order a carwash service or modify an existing order by the customer's parking lot number in a parking facility, as shown in STEP 501. In one or more embodiments of the invention, a computerized user interface provided by an integrated carwash kiosk application or by an integrated carwash customer order application can enable the customer to order the carwash service or modify the existing order by the customer's parking lot number.

Then, the customer's new order or modifications to a previous order can be stored in the client service management database, which is at least in part managed by an integrated carwash service management application, as shown in STEP 502. This carwash scheduling update process, in accordance with the flowchart (500), may be particularly useful for a car parking facility-based hand carwash service, which is electronically coordinated, assisted, and provided by the integrated carwash client service management system and the integrated carwash service management application executed in one or more computer servers.

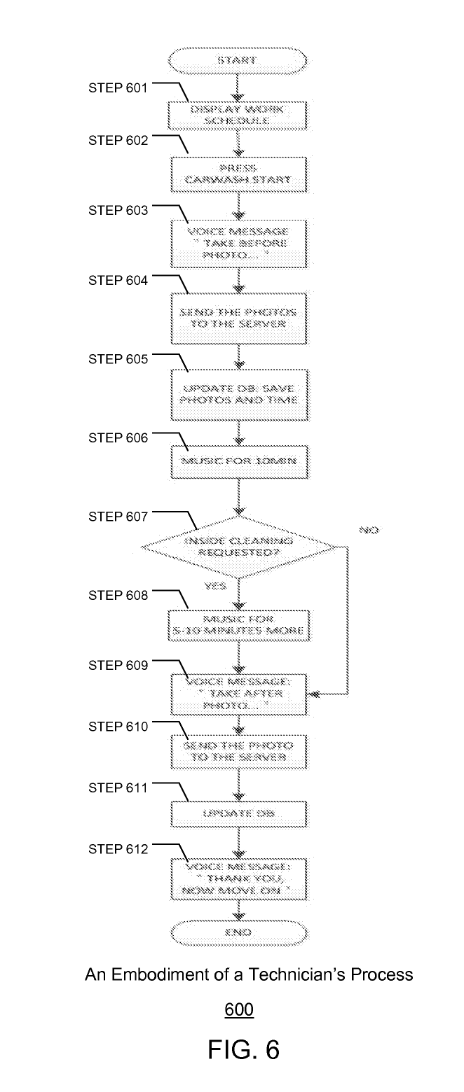

FIG. 6 shows a flowchart (600) for a carwash technician's interactive process with the integrated carwash client service management system, in accordance with an embodiment of the invention. In this embodiment, the carwash technician utilizes an integrated carwash order processing application (41 in FIG. 1), which is executed in a CPU and a memory unit of a carwash technician device (40 in FIG. 1). Preferably, the carwash technician device is a portable electronic communication device, such as a smart phone or a tablet computer, which is carried by the carwash technician to an onsite carwash location. The onsite carwash location may be a customer's designated parking space in a car parking facility, or a designated location within the car parking facility for carwash services.

As shown in STEP 601 of FIG. 6, the integrated carwash order processing application executed in the carwash technician device displays the carwash technician's work schedule in an interactive user interface. The carwash technician can check his or her work schedule on the interactive user interface, which includes a list of vehicles that need to be washed and/or cleaned within a particular time frame. Then, for a particular vehicle listed in the work schedule, the carwash technician can press a “carwash start” button on the interactive user interface provided by the carwash technician device, as shown in STEP 602. After pressing the “carwash start” button, the integrated carwash order processing application and the integrated carwash service management application can provide a computerized step-by-step assistance and instruction to the carwash technician device for performing pre-carwash, carwash, and post-carwash tasks, which are required from the carwash technician for the particular vehicle in the work schedule.

For example, the computerized step-by-step assistance and instruction may begin with a voice message that says “take a photo of a vehicle prior to carwash . . . ,” as shown in STEP 603. Once the carwash technician takes the photo of the vehicle by utilizing the carwash technician device or a standalone digital camera, the photo of the vehicle prior to carwash is electronically transmitted to a computer server executing the integrated carwash service management application, as shown in STEP 604. The photo of the vehicle prior to carwash and a corresponding timestamp are then saved in a computer server or a data storage associated with a client service management database operated by the computer server, as shown in STEP 605. Then, the carwash technician proceeds to wash the exterior of the vehicle, during which music may be optionally played by the carwash technician device, as shown in STEP 606.

Once the exterior of the vehicle is washed, cleaned, and/or waxed, depending on a particular carwash service order from the customer, the computerized step-by-step assistance and instruction provided by the integrated carwash client service management system can optionally display additional instructions and/or play music for interior cleaning, if the interior cleaning is requested by the customer, as shown in STEP 607 and STEP 608. After the carwash (e.g. washing, cleaning, waxing, and etc., depending on a particular carwash service order) is completed, the computerized step-by-step assistance and instruction provided by the integrated carwash client service management system generate a voice guidance to take an after-carwash photo of the vehicle, as shown in STEP 609. The carwash technician then takes an after-carwash photo of the vehicle, and the carwash technician device electronically transmits the after-carwash photo of the vehicle to the computer server executing the integrated carwash service management application, as shown in STEP 610. The photo of the vehicle after the carwash and a corresponding timestamp are then saved in a data storage associated with the client service management database operated by the computer server, as shown in STEP 611. Lastly, the computerized step-by-step assistance and instruction provided by the integrated carwash client service management system can further generate a voice guidance to thank the carwash technician and to proceed to the next vehicle for carwash, as shown in STEP 612. Preferably, the computerized step-by-step assistance and instruction are given through the interactive user interface displayed by the carwash technician device, such as a smart phone or a tablet computer.

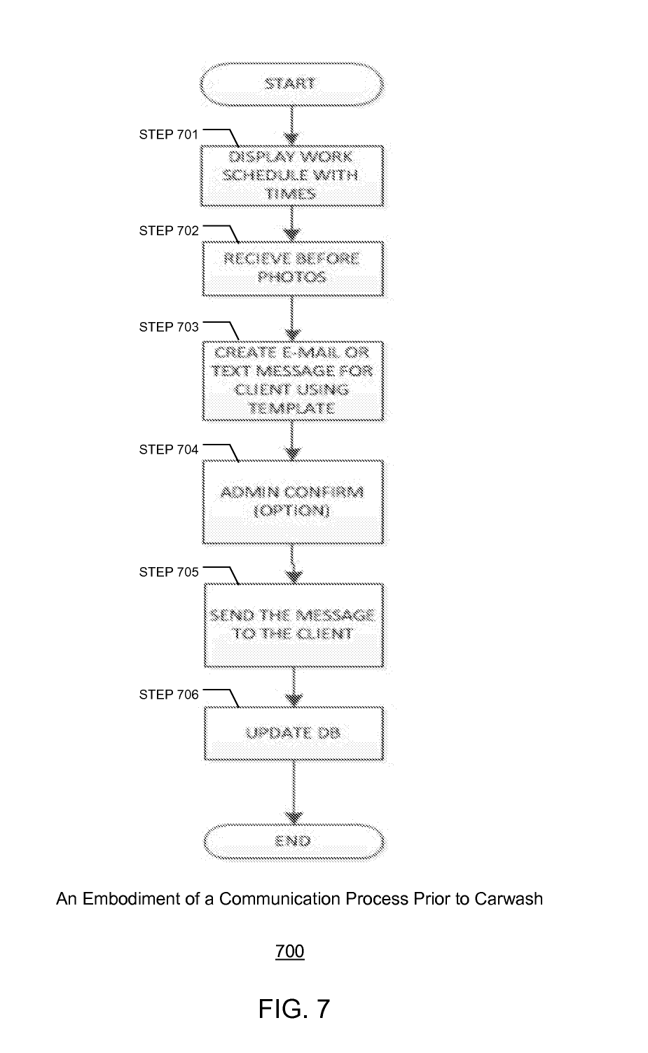

FIG. 7 shows a flowchart (700) for a communication process generated by an integrated carwash client service management system before a carwash operation, in accordance with an embodiment of the invention. For example, the integrated carwash client service management system can display work schedule for a carwash technician on a carwash technician device's display screen with a corresponding time slot for a carwash work order, as shown in STEP 701. Once the carwash technician sends one or more “before carwash” photos, which is received by a computer server operating the integrated carwash client service management system, as shown in STEP 702, the integrated carwash client service management system can create an e-mail, a text message, or another form of electronic communication using a particular template for communicating with a customer corresponding to the carwash work order, as shown in STEP 703.

Then, as an option, an administrator can confirm the content of the communication from the carwash technician to the customer prior to sending out the completed and/or filled-out template to the customer, if a personalized moderation for messaging between the carwash technician and the customer is desired by a particular carwash service business, as shown in STEP 704. In case of using the personalized moderation via the administrator, if the content of the communication from the carwash technician to the customer is approved, then the content of the message can be transmitted to a customer's user interface device, as shown in STEP 705. Furthermore, a client service management database that keeps track of the content of the communication between the carwash technician and the customer can be updated with new messages, one or more “before carwash” photos, and other pertinent information, as shown in STEP 706.

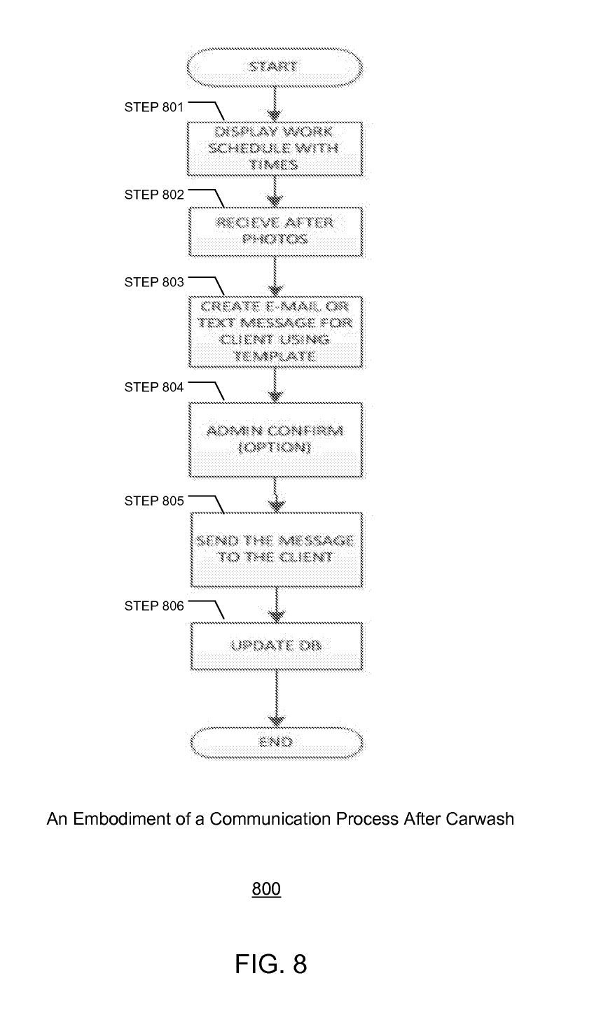

FIG. 8 shows a flowchart (800) for a communication process generated by an integrated carwash client service management system after a carwash operation, in accordance with an embodiment of the invention. In this embodiment of the invention, the integrated carwash client service management system displays work schedule with a corresponding time slot for a carwash work order, which is now completed, as shown in STEP 801. Once a carwash technician sends one or more “after carwash” photos, the integrated carwash client service management system receives these “after carwash photos” and store them in a computer server associated with a client service management database with an associated timestamp, as shown in STEP 802.

Then, the integrated carwash client service management system can create an e-mail, a text message, or another form of electronic communication using a particular template for communicating with a customer corresponding to the carwash work order, as shown in STEP 803. Subsequently, as an option, an administrator can confirm the content of the communication from the carwash technician to the customer prior to sending out the completed and/or filled-out template to the customer, if a personalized moderation for messaging between the carwash technician and the customer is desired by a particular carwash service business, as shown in STEP 804. In case of using the personalized moderation via the administrator, if the content of the communication from the carwash technician to the customer is approved, then the content of the message can be transmitted to a customer's user interface device, as shown in STEP 805. Furthermore, a client service management database that keeps track of the content of the communication between the carwash technician and the customer can be updated with new messages, one or more “after carwash” photos, and other pertinent information, as shown in STEP 806.

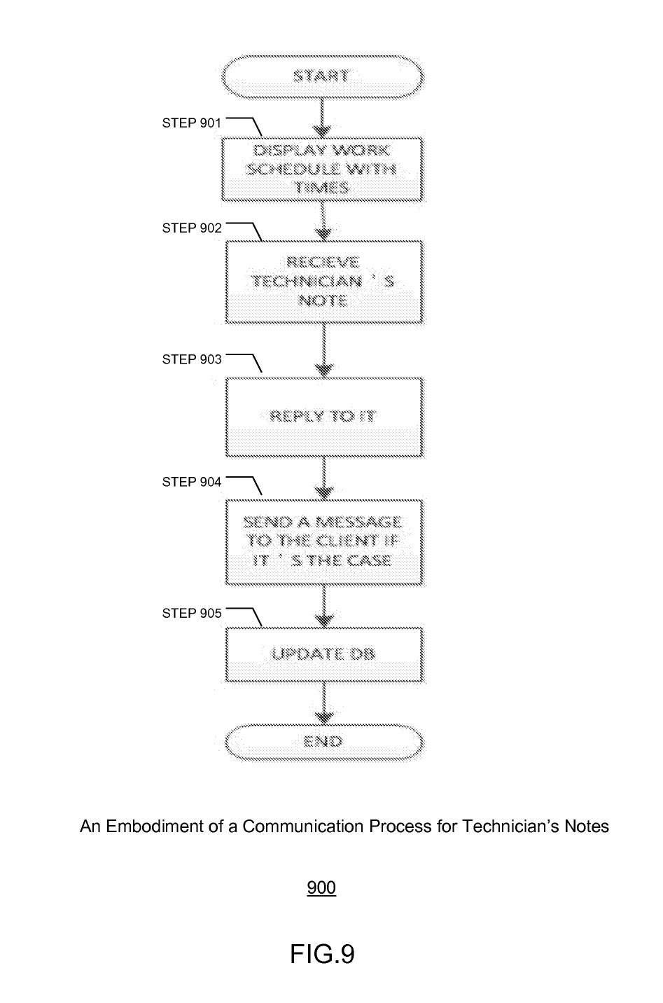

FIG. 9 shows a flowchart (900) for a communication process generated by an integrated carwash client service management system for a carwash technician's note, in accordance with an embodiment of the invention. In this example, the integrated carwash client service management system can first display work schedule with a corresponding time slot for a carwash work order on a carwash technician's user interface device, as shown in STEP 901. Then, the carwash technician can enter notes or messages associated with the carwash work order, as shown in STEP 902. In one embodiment of the invention, either an administrator or a carwash customer can respond to the carwash technician's notes, if it is appropriate to do so, as shown in STEP 903. If the carwash technician's notes are appropriate or desirable for communicating with the customer, then the carwash technician's notes can be transmitted to the customer's electronic device, as shown in STEP 904. In addition, a client service management database that keeps track of the content of the carwash technician's notes in association with the integrated carwash client service management system can store all or part of the pertinent information for subsequent usage, as shown in STEP 905.

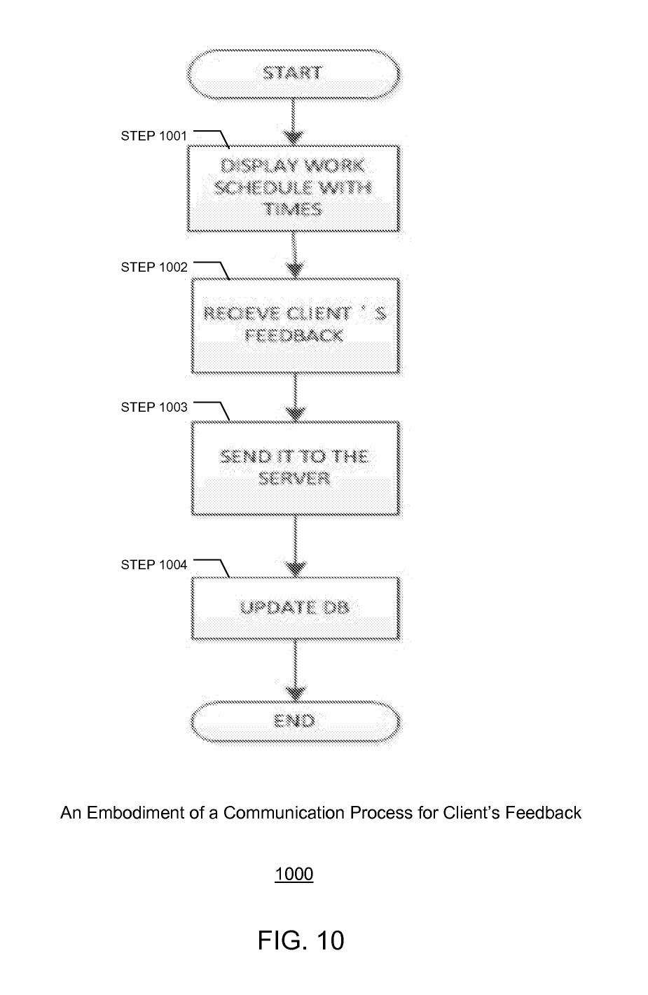

FIG. 10 shows a flowchart (1000) for a communication process generated by an integrated carwash client service management system for a customer's feedback, in accordance with an embodiment of the invention. In this example, the integrated carwash client service management system can first display work schedule with a corresponding time slot for a carwash work order on a carwash customer's user interface device, as shown in STEP 1001. Then, the carwash customer's user interface device can capture the carwash customer's feedback, as shown in STEP 1002, and transmit the customer feedback information to a computer server associated with the integrated carwash client service management system, as shown in STEP 1003. In addition, a client service management database that keeps track of the content of the carwash customer's feedback can store all or part of the customer feedback information for subsequent usage in the integrated carwash client service management system, as shown in STEP 1004.

FIG. 11 shows a method (1100) for operating an integrated carwash client service management system, in accordance with an embodiment of the invention. In a preferred embodiment of the invention, the integrated carwash client service management system comprises an integrated carwash service management application executed in a computer server, an integrated carwash customer order application executed in a customer's electronic device, an integrated carwash order processing application executed in a carwash technician device, and an integrated carwash kiosk application executed in an electronic kiosk machine, as previously described for FIG. 1. These elements are operatively connected to each other for data communication via a combination of wired and wireless data networks, as also previously described for FIG. 1.

The first step in operating the integrated carwash client service management system is to start up each element of the integrated carwash client service management system, including the integrated carwash service management application executed in the computer server, the integrated carwash customer order application executed in the customer's electronic device, the integrated carwash order processing application executed in the carwash technician device, and the integrated carwash kiosk application executed in the electronic kiosk machine, as shown in STEP 1101. Furthermore, an administrator and/or a carwash technician may want to log into the integrated carwash client service management system by accessing the integrated carwash order processing application and the integrated carwash service management application, as also shown in STEP 1101.

Then, a carwash customer completes a carwash order and an associated payment, which is processed by the integrated carwash service management application executed in the computer server and also by payment processing entities, as shown in STEP 1102. The carwash customer can complete the carwash order and the associated payment by utilizing an interactive menu displayed by the customer's electronic device executing the integrated carwash customer order application. Alternatively, the carwash customer can also complete the carwash order and the associated payment by utilizing an interactive menu displayed by the integrated carwash kiosk application executed in the electronic kiosk machine.

Once the carwash order and the associated payment are completed, the integrated carwash service management application executed in the computer server can queue in the carwash order into a client service management database, which is also stored and managed by the computer server. The integrated carwash service management application is configured to determine a level of priority processing for the carwash order, based on whether the carwash order is a rush request or not. The integrated carwash service management application is able to execute the carwash scheduling process, as shown in STEP 1103, and also generates computerized instructions and assistance for the carwash technician's pre-carwash, carwash, and post-carwash tasks that are defined and coordinated by the integrated carwash service management application.

Then, the integrated carwash service management application executed in the computer server communicates with the integrated carwash order processing application executed in the carwash technician devices to provide a computerized voice and/or visual display assistance for the carwash technician's pre-carwash tasks, which include taking a photo of the customer's vehicle prior to carwash, as shown in STEP 1104. Furthermore, the integrated carwash service management application and the integrated carwash order processing application also provide the computerized voice and/or visual display assistance for the carwash technician's carwash tasks during the carwash itself, as shown in STEP 1105. If there are any reasons to communicate with the carwash customer in the middle of the carwash, as shown in STEP 1106, the integrated carwash service management application and the integrated carwash order processing application can provide an electronic messenger service, an email service, or another alert service via data networks to transmit the urgent message from the carwash technician to the carwash customer, as shown in STEP 1109.

Furthermore, after the carwash is completed, the integrated carwash service management application and the integrated carwash order processing application also provide the computerized voice and/or visual display assistance for the carwash technician's post-carwash tasks, which include taking a photo of the customer's vehicle after the carwash, as shown in STEP 1107. Optionally, the integrated carwash client service management system can also receive and store the carwash customer's feedback, as shown in STEP 1108.

Various embodiments of the present invention provide significant advantages over conventional carwash systems and methods. For example, an embodiment of the present invention provides a novel integrated carwash client service management system with embedded and mobile application software that receives carwash requests and schedule, coordinate, and manage a car parking facility-based hand carwash service. Furthermore, an embodiment of the present invention also provides a user interface application software and user interface devices that can enter a customer's carwash request and carwash technician's various inputs in real-time to schedule, view, share, and generate feedback during and after the car parking facility-based hand carwash service. In addition, an embodiment of the present invention also provides a real-time communication and an e-commerce transaction network to accommodate a customer's carwash fee payment and various communication needs between the customer and the carwash technicians after the customer's carwash request is accepted by the novel integrated carwash client service management system.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated carwash client service management system comprising:
an integrated carwash customer order application executed in a customer's electronic device, wherein the integrated carwash customer order application provides a carwash order and payment interactive user interface on a display screen of the customer's electronic device;
an integrated carwash order processing application executed in a carwash technician's electronic device, wherein the integrated carwash order processing application provides a carwash work schedule and a computerized voice or visual instruction for the carwash technician's pre-carwash, carwash, and post-carwash tasks on the carwash technician's electronic device; and
an integrated carwash service management application executed in a computer server, wherein the integrated carwash service management application communicates with the integrated carwash customer order application executed in the customer's electronic device, the integrated carwash order processing application executed in the carwash technician's electronic device, and a client service management database to coordinate and assist a hand car wash in a car parking facility that involves the carwash technician locating and washing a vehicle on the customer's designated parking space in the car parking facility.

2. The system of claim 1, further comprising an integrated carwash kiosk application executed in an electronic kiosk machine, wherein the integrated carwash kiosk application provides a kiosk-based interactive user interface to enable the customer to choose a particular carwash service and reserve or pay for the particular carwash service electronically on the electronic kiosk machine.

3. The system of claim 1, further comprising a combination of wired and wireless data networks that enable data communication among the customer's electronic device, the carwash technician's electronic device, the computer server, and the client service management database.

4. The system of claim 1, further comprising a payment processing system that verifies and confirms a successful or unsuccessful payment by the customer.

5. The system of claim 1, wherein the customer's electronic device is a smart phone, a tablet computer, a notebook computer, or a desktop personal computer.

6. The system of claim 1, wherein the carwash technician's electronic device is a smart phone, a tablet computer, a notebook computer, or a desktop personal computer.

7. The system of claim 1, wherein the carwash work schedule and the computerized voice or visual instruction for the carwash technician's pre-carwash, carwash, and post-carwash tasks are generated by the integrated carwash service management application executed in the computer server, and then transmitted to the integrated carwash order processing application executed in the carwash technician's electronic device.

8. The system of claim 1, wherein the carwash technician's pre-carwash, carwash, and post-carwash tasks involve taking a before-carwash photo and an after-carwash photo, and transmitting the before-carwash photo and the after-carwash photo to the integrated carwash service management application, which is executed in the computer server.

9. The system of claim 1, wherein the integrated carwash customer order application and the integrated carwash order processing application are mobile device applications that are downloadable and executable in a smart phone or a tablet computer.

10. The system of claim 1, wherein the integrated carwash customer order application is configured to read a QR code or a bar code representing the carwash order, a payment coupon, or a discount coupon.

11. The system of claim 1, wherein the integrated carwash customer order application and the integrated carwash order processing application are configured to send and receive messages, photos, and emails between the carwash technician and the customer throughout the carwash technician's pre-carwash, carwash, and post-carwash tasks.

12. A method of operating an integrated carwash client service management system, the method comprising steps of:
executing an integrated carwash service management application in a computer server;
executing an integrated carwash customer order application in a customer's electronic device;
executing an integrated carwash order processing application in a carwash technician's electronic device;
executing an integrated carwash kiosk application in an electronic kiosk machine;
receiving a carwash order and an associated payment via an interactive user interface provided by a display panel in the customer's electronic device executing the integrated carwash customer order application, or by a kiosk display panel in the electronic kiosk machine executing the integrated carwash kiosk application;
processing the associated payment by the computer server and by a payment processing entity;
storing the carwash order in a client service management database operated by the integrated carwash service management application and the computer server;
generating computerized voice or visual instructions for the carwash technician's pre-carwash, carwash, and post-carwash tasks that are defined by the integrated carwash service management application;
transmitting the computerized voice or visual instructions to the carwash technician's electronic device; and
playing the computerized voice or visual instructions on the carwash technician's electronic device, so that the carwash technician follows each instruction from the computerized voice or visual instructions for the carwash technician's pre-carwash, carwash, and post-carwash tasks.

13. The method of claim 12, further comprising a step of generating a message or an email for communication between the carwash technician's electronic device and the customer's electronic device during a playback of the computerized voice or visual instructions for the carwash technician's pre-carwash, carwash, and post-carwash tasks.

14. The method of claim 12, wherein the customer's electronic device is a smart phone, a tablet computer, a notebook computer, or a desktop personal computer.

15. The method of claim 12, wherein the carwash technician's electronic device is a smart phone, a tablet computer, a notebook computer, or a desktop personal computer.

16. The method of claim 12, wherein the carwash technician's pre-carwash, carwash, and post-carwash tasks involve taking a before-carwash photo and an after-carwash photo, and transmitting the before-carwash photo and the after-carwash photo to the integrated carwash service management application, which is executed in the computer server.

17. The method of claim 12, wherein the integrated carwash customer order application and the integrated carwash order processing application are mobile device applications that are downloadable and executable in a smart phone or a tablet computer.

18. The method of claim 12, wherein the integrated carwash customer order application is configured to read a QR code or a bar code representing the carwash order, a payment coupon, or a discount coupon.

19. The method of claim 12, wherein the integrated carwash customer order application and the integrated carwash order processing application are configured to send and receive messages, photos, and emails between the carwash technician and the customer throughout the carwash technician's pre-carwash, carwash, and post-carwash tasks.
